(19) United States
(12) Patent Application Publication
(10) Pub. No.: US 2013/0186824 A1
(43) Pub. Date: Jul. 25, 2013

(54) Spiral Cross Flow Membrane Filtration Device And Process

(71) Applicants: James Jeffrey Harris, Cameron Park, CA (US); Keith Lampi, Corvallis, OR (US)

(72) Inventors: James Jeffrey Harris, Cameron Park, CA (US); Keith Lampi, Corvallis, OR (US)

(73) Assignee: HYDRATION SYSTEMS, LLC, Scottsdale, AZ (US)

(21) Appl. No.: 13/355,357

(22) Filed: Jan. 20, 2012

(51) Int. Cl. B01D 65/02; B01D 61/00; B01D 63/08

(52) U.S. Cl. 210/636; 210/321.84; 210/321.85; 210/650

(57) ABSTRACT

Disclosed is a membrane filtration device and process affording high velocity cross flow membrane purging via cyclonic spiraling flow; hydraulically induced about stacked plate type membrane configurations. No piping, conduits or other flow impediments are enclosed to generate streamline or shadow depositions, and periodic reversals of cyclonic flow for enhanced membrane scouring and flushing may be employed.

### BACKGROUND

1. Technical Field

This document relates to membrane filtration, specifically to a spiral cross flow membrane filtration device and process.

2. Background

Conventional configurations and schemes exist that try to improve cross flow velocity to reduce the propensity for fouling and scaling of membranes. However, these efforts are expensive, unreliable, and operationally problematic. Further, these efforts generally employ configurations not optimal to provide full cross flow coverage of the fouling prone membrane surfaces.

An example of such ineffective conventional configurations and schemes includes the application of turbulence generating feed water spacing media within the confines of spiral wound media. These efforts to try and improve fouling resistance of spiral wound membranes however have meet with little success simply because of the flow limitations inherent to the spiral wound membrane configuration. A further difficulty inherent to spiral wound membranes is the inability to effectively clean severely fouled membranes exasperated by the inability to expose the permanently rolled membrane material for physical cleaning.

These troublesome issues have lead to reconfiguration of membranes away from early spiral wound configurations.

For example, cassette packaging of linear, flat membranes has been introduced but has inefficiencies in flow distribution and associated inferior performance, as well as suffering from the required multiplicity of seals, and hence, severe problems associated with leakage.

As another example, circular flow patterns and associated circular membrane configurations have been presented. However, they suffer substantially from high pressure drop and, as a consequence of the geometrical configuration, ineffectively low cross flow velocity across the outer radii of the circular membranes. This is an especially inferior configuration since the outer radii encompasses the majority of the membrane surface area. This presentation accordingly has low velocity across the majority of the membranes resulting in high fouling problems.

As a further example, membrane surfaces have been mechanically spun. However, they encumber sealing problems inherent to rotating mechanisms within a pressured fluid environment. Further, these examples suffer from an inability to maintain an induced high cross flow relative velocity on the membranes due to induced swirl of the fluid surrounding the rotating membranes. The induced swirl substantially reduces cross flow and indeed, especially reduces the cross flow velocity to near zero at inward radii.

As still another example, multiple counter-rotating membrane disks have been presented. But they substantially complicated in design and are plagued with inherent sealing and mechanical failings.

As yet another example, other mechanically induced swirl cross flow manifestations have also been presented using spinning blades. These efforts suffer from complex, expensive and unreliable high load rotating seals. Also, the complexity of the mechanical design burdens this design with difficult and burdensome maintenance requirements. This design is further taxed by a high power requirement and accompanying high operating expense.

Finally, as still another example, configurations have been presented wherein a swirl is induced via entrained piping. This approach is burdened by the fluid dynamic burdens of the piping placement within the swirl pattern. Relative cross flow velocities and swirl path coverage are dramatically hindered by the presence of such piping as well. Furthermore, flow shadows on the membranes from the piping manifest as low cross flow velocity areas prone to unresolvable fouling presenting an inherent, serious flaw.

Thus, important and burdensome disadvantages of conventional membrane filtration processes are inefficiency, unreliability, operational difficulty, minimal durability, plugging, fouling and blinding associated with treating poor quality feed fluids with high solids content.

### SUMMARY

Aspects of this document generally relate to operational enhancement of membrane filtration processes, and specifically relate to a spiral cross flow membrane filtration device and process that reduces fouling and scaling by employing high velocity cross flow to minimize solids deposition upon the membrane surface. These aspects may include, and implementations may include, one or more or all of the components and steps set forth in the appended CLAIMS, which are hereby incorporated by reference.

In one particular aspect, a spiral cross flow membrane filtration device may include a large diameter hollow cylindrical vessel in the walls of which may be at least two tangentially oriented, but circumferentially opposing inlet slots or ports for feed fluid. Also suspended, longitudinally and central to the vessel, may be a compressed stack of alternating large diameter, two sided membrane covered plates and much small diameter spacers. The longitudinal center of the stack may contain multiple conduits to independently convey multiple fluids.

Particular forward osmosis implementations may include one or more or all of the following. A central conduit supplies a rich draw solution, another conduit removes a lean draw solution, and the third conduit provides reject drainage of a spent feed solution. The rich draw solution conduit conveys rich draw solution to flow basins underneath the membranes on the outer plate surfaces. Hollow interiors of the plates drain and convey permeate diluted lean draw solution from the membranes to the lean draw solution conduit for conveyance from the device and process. The reject conduit is open through the spacers to the gap between the membrane plates and conveys spent feed fluid from the process.

In another particular aspect, a process of spiral cross flow membrane filtration is disclosed. The process may include the steps of: conveying feed fluid at high velocity through one of the two tangentially oriented inlet slots or ports of the vessel, generating a large cyclonic swirl about the vessel and membrane plates; conveying the cyclonically motivated feed fluid radially into the spacers between the membrane plates, generating an inward spiraling high velocity flow across the membranes, inward flow providing angular acceleration and higher velocity across the membranes, high velocity across the membranes providing superior cleaning proficiency; conveying rich draw solution into the rich draw solution conduit, rich draw solution conveying from this conduit across the plates in contact with and under the membranes, osmotic pressure extracting permeate from the swirling feed fluid through the membranes, the rich draw solution diluting with the permeate; the diluted draw solution being internally conveyed in the plates, from the permeate dilution of the membranes to the lean draw solution conduit; the lean draw solution being discharged from the lean draw solution conduit; feed fluid lessened from permeate loss conveys through the spacers into the reject conduit, the reject conduit then discharging the permeate reduced feed fluid; the high velocity feed fluid to the vessel being periodically diverted between opposing inlet slots or ports, the cyclonic swirl about the vessel and membranes periodically reversing direction, flow reversal breaking loose streamlined detritus and other flow shaded debris, the membrane surface cleaning proficiency being enhanced.

The foregoing and other aspects and implementations of a spiral cross flow membrane filtration device and process may have one or more or all of the following advantages, as well as other benefits discussed elsewhere in this document.

The excellent attributes of a spiral cross flow membrane filtration device and process afford the trouble free application of all types of membrane filtration media and associated applications; coarse strainer, microfilter, ultrafilter, nanofilter, reverse osmosis and, especially, forward osmosis. The cleanliness and ease of service substantially advances the durability of membranes and minimizes the cleaning, flushing and associated maintenance burdens typical of conventional techniques.

Other advantages include: a) enhanced reliability, presenting minimal downtime for cleaning and service; b) minimizing chemical costs for cleaning and washing; c) maximizing membrane life and performance expectancy; d) enhanced flux rates and performance; e) lower pumping energy use requirements; f) elimination of pretreatment equipment capital and operating expense; g) the capability to treat fluids to higher levels of solids enabling increased product quantity and less waste; h) ease of membrane service, repair and replacement, especially in the field; i) higher membrane performance by maximizing membrane contact area subsequent to elimination of streamline and shadow solids deposition on membrane surfaces; j) superior membrane performance and durability solely through the employ of simple, membrane safe hydraulic flow cleansing processes; k) superior forward osmosis flux by employing full countercurrent flow regimes; l) continuous membrane filtration and heavy solids blowdown without the burdensome batch cleaning requirements of conventional membrane filtration processes; and m) true parallel contacting, minimizing the inefficiencies and losses associated with reduced gradient flux as burdens conventional series configurations.

The foregoing and other aspects, features, and advantages will be apparent to those of ordinary skill in the art from the DESCRIPTION and DRAWINGS, and from the CLAIMS.

### BRIEF DESCRIPTION OF DRAWINGS

Implementations will hereinafter be described in conjunction with the appended DRAWINGS (which are not necessarily to scale), where like designations denote like elements, and:

FIG. 1 is a frontal view of a spiral cross flow membrane pressure filtration device implementation in which the capability for only a unidirectional fluid input is depicted;

FIG. 2 is a frontal view of a spiral cross flow membrane forward osmosis filtration device implementation in which the capability for only a unidirectional fluid input is depicted;

FIG. 3 is an isometric view of a membrane support side of a membrane plate of the spiral cross flow membrane pressure filtration device implementation of FIG. 1, having a membrane removed for clarity, depicting an under-membrane basin, a plate central hub with incorporated penetrations and flow ducts, membrane support spacers, and membrane attachment clasp;

FIG. 4 is an isometric view of the membrane plate of FIG. 2 with a membrane in place;

FIG. 5 is an isometric view of a spacer element of the spiral cross flow membrane pressure filtration device implementation of FIG. 1 illustrating both the longitudinal and radial penetrations therein;

FIG. 6 is an isometric view of an assembled membrane ensconced plate sandwiched between two spacers of the spiral cross flow membrane pressure filtration device implementation of FIG. 1;

FIG. 7 is an isometric view of a stacking assembly comprised of pressured membrane plate and spacer assemblies of the spiral cross flow membrane pressure filtration device implementation of FIG. 1;

FIG. 8 depicts is an isometric view of a membrane support side of a membrane plate of the spiral cross flow membrane forward osmosis filtration device implementation of FIG. 2, having a membrane removed for clarity, depicting a under-membrane basin upon which draw solution flows, a plate central hub incorporating a of recycle fluid penetration, a lean draw solution penetration, rich draw solution ports and associated ducts providing flow conveyance from the rich draw solution port to the under-membrane basin, membrane support spacers, and membrane attachment and assembly clasp;

FIG. 9 is an isometric view of a lean draw solution hollow return side of the membrane plate of FIG. 8, depicting a hollow return core with structural supports, lean draw solution return holes at the outer periphery of the return core, central hub, recycle and rich draw solution penetrations, lean draw solution ports and associated ducts providing flow conveyance from the return core to the lean draw solution ports, and membrane and assembly attachment clasp mounting holes at the outer radius;

FIG. 10 is an isometric view of the membrane plate of FIG. 8 with a membrane in place;

FIG. 11 is an isometric view of a spacer of the spiral cross flow membrane forward osmosis filtration device implementation of FIG. 2 illustrating the longitudinal penetrations for lean draw solution, rich draw solution and recycle fluid as well as the radial penetrations traversing from the external region of the spacer to the longitudinal internal recycle fluid penetration;

FIG. 12 is an isometric view of a spacer sandwiched, mirror mated two half plate assemblage manifesting the dual membrane sided, hollow return core interior configuration of the spiral cross flow membrane forward osmosis filtration device implementation of FIG. 2;

FIG. 13 is an isometric view of a stacking assembly of membrane plate and spacer assemblies of the spiral cross flow membrane forward osmosis filtration device implementation of FIG. 2;

FIG. 14 is a frontal view of another spiral cross flow membrane pressure filtration device implementation in which multiple unidirectional fluid input is depicted;

FIG. 15 depicts a frontal view of another spiral cross flow membrane forward osmosis filtration device implementation in which multiple unidirectional fluid input is depicted;

FIG. 16 depicts a frontal view of another spiral cross flow membrane pressure filtration device implementation in which directionally opposing fluid input slots are depicted but of which high velocity feed fluid is addressing only those directing clockwise cyclonic flow;

FIG. 17 depicts a frontal view of another spiral cross flow membrane forward osmosis filtration device implementation in which directionally opposing fluid input slots are depicted but of which high velocity feed fluid is addressing only those directing clockwise cyclonic flow;

FIG. 18 depicts a frontal view of another spiral cross flow membrane pressure filtration device implementation in which directionally opposing fluid input slots are depicted but of which high velocity feed fluid is addressing only those directing counter-clockwise cyclonic flow;

FIG. 19 depicts a frontal view of another spiral cross flow membrane forward osmosis filtration device implementation in which directionally opposing fluid input slots are depicted but of which high velocity feed fluid is addressing only those directing counter-clockwise cyclonic flow;

FIG. 20 depicts a frontal view of another spiral cross flow membrane pressure filtration device implementation in which a directionally opposing fluid input slot is depicted but of which high velocity feed fluid is addressing only those directing clockwise cyclonic flow whereas the one opposing slot is scavenging fluid and solid detritus from the outer periphery of the cyclonic flow;

FIG. 21 depicts a frontal view of another spiral cross flow membrane forward osmosis filtration device implementation in which a directionally opposing fluid slot is depicted but of which high velocity feed fluid is addressing only those directing clockwise cyclonic flow whereas the one opposing slot is scavenging fluid and solid detritus from the outer periphery of the cyclonic flow;

FIG. 22 depicts a frontal view of another spiral cross flow membrane pressure filtration device implementation in which directionally opposing fluid input slots are depicted but of which high velocity feed fluid is addressing only those directing clockwise cyclonic flow, whereas one of the opposing slots is employed to scavenge fluid and solid detritus from the outer periphery of the cyclonic flow while not presenting feed fluid ingress; and

FIG. 23 depicts a frontal view of another spiral cross flow membrane forward osmosis filtration device implementation in which directionally opposing fluid input slots are depicted but of which high velocity feed fluid is addressing only those directing clockwise cyclonic flow, whereas one of the opposing slots is employed to scavenge fluid and solid detritus from the outer periphery of the cyclonic flow while not presenting feed fluid ingress;

### DESCRIPTION

This document features a membrane filtration device and process that afford high efficiency solids removal, filtration and/or conditioning of liquids. The device and process purveys high quality, durable membrane treatment in liquid applications especially burdened by high suspended solids loading. The device and process conveys superior treatment for providing clean permeate liquid by means of pressured membrane filtration or liquid extraction by means of forward osmosis. Thus, there are many features of membrane filtration device and process implementations disclosed herein, of which one, a plurality, or all features or steps may be used in any particular implementation.

In the following description, reference is made to the accompanying DRAWINGS which form a part hereof, and which show by way of illustration possible implementations. It is to be understood that other implementations may be utilized, and structural, as well as procedural, changes may be made without departing from the scope of this document. As a matter of convenience, various components will be described using exemplary materials, sizes, shapes, dimensions, and the like. However, this document is not limited to the stated implementations and examples and other configurations are possible and within the teachings of the present disclosure.

A membrane filtration device and process will be described with respect to implementations in specific contexts, namely as a device and process for pressured membrane filtration and for forward osmosis treatment of highly solids laden fluids. Implementations of a membrane filtration device and process may also be applied, however, to other situations wherein sheet filtration or treatment is desirable. Furthermore, it should be appreciated by those skilled in the art that the conception and specific implementations disclosed may be readily utilized as a basis for modifying or designing other structures or processes for carrying out the same purposes of the present disclosure. It should also be realized by those skilled in the art that such equivalent constructions do not depart from the spirit and scope of the disclosure set forth in this document.

Membrane filtration device and process implementations employ the concept of cyclonic flow, conservation of angular momentum and geometrical influence to generate high cross-flow velocities upon the reject side of sheet membrane material. High cross-flow velocities scour solids and detritus deposits from the membranes, dramatically reducing operational maintenance, improving membrane performance and durability. The benefits provided are furthered by fashioning the device to impart periodic reversal of the cyclonic direction across the membranes; affording multidirectional cross-flow and the associated scouring enhancements, such as elimination of layering, stream line and shadow depositions.

There are a variety of membrane filtration device implementations.

In pressure filter implementations at least three fluid types partake in the device and process; feed fluid, permeate fluid, and reject fluid. Feed fluid is the fluid being treated often also referred to as the challenge fluid. Permeate is the fluid which passed through the membrane. In the case of coarse filtration permeate is also termed filtrate. Reject fluid is the residual fluid after permeate has been extracted from the feed fluid. These implementations accordingly have one fluid ingress as feed fluid and two fluid egresses as permeate fluid and reject fluid. Processing and handling of these three fluids are external to the present disclosure, subsequently not of significance herein.

In forward osmosis implementations at least four fluid types partake in the device and process; feed fluid, rich draw solution, lean draw solution, and reject fluid. Feed fluid is the fluid being treated. Rich draw solution provides the osmotic pressure across the membranes to draw permeate from the feed fluid to dilute the rich draw solution. Lean draw solution is rich draw solution diluted with permeate. Reject fluid is the residual feed fluid after permeate has been extracted. Such implementations may have two fluid ingresses, feed fluid and rich draw solution, and two fluid egresses, reject fluid and lean draw solution. Processes and handling of these four fluids are external to the present disclosure, subsequently not of significance herein.

### Spiral Cross Flow Membrane Pressure Filtration Device

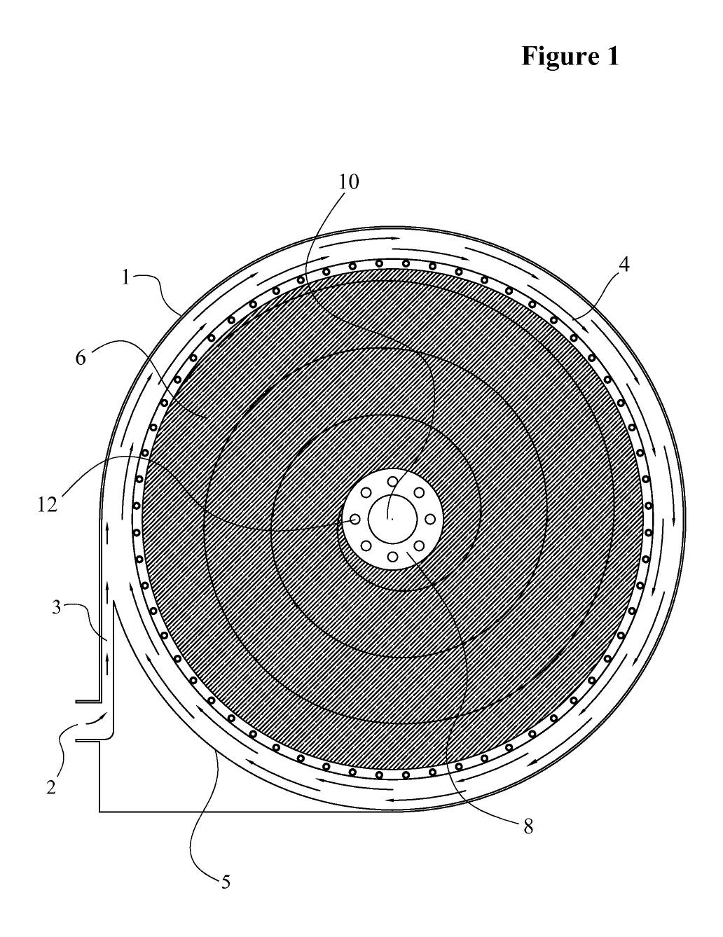

Notwithstanding, turning to FIGS. 1 and 3-7 and for the exemplary purposes of this disclosure, a spiral cross flow membrane pressure filtration device is shown.

With reference to FIG. 1, a vessel 1 encloses a circular region 5 (or cylindrical as the case may be) in which one or more membrane sided plate assemblies 6 are centrally located. The plate assemblies are sandwiched between much smaller diameter cylindrical spacers 8, fashioning a longitudinal stack within the vessel. The spacers and plates are penetrated with two or more longitudinal penetrations to convey separate fluids into, within, and from the stack. The wall of the circular region 5 is penetrated with a fluid inlet 3. Feed fluid 2 is introduced at high velocity, typically ranging from 1 to 15 m/sec through the fluid inlet 3 into the circular region 5 of the vessel 1. Higher inlet velocities are advantageous to enhance membrane cleanliness by inducing higher cross flow velocities upon the membrane surfaces; albeit with a caveat of higher power requirements. Accordingly, the inlet velocities are balanced to maximize membrane cleanliness but yet do so with a reasonable power requirement. A typical balance is about 5 m/sec inlet velocity. The fluid inlet 3 addresses the circular region 5 tangentially to engender cyclonic swirl 4 of the feed fluid 2 about the circular region 5. The spacers 8 are penetrated to convey feed fluid from the central region of the circular region 5 into a recycle conduit 10 which extends the length of the stack and egresses from vessel 1. Fluid exiting the vessel via conveyance through the spacers 8 and recycle conduit 10 affects an inward radial flow component to the cyclonic swirl 4. Accordingly the cyclonic swirl 4 progresses inward between the membrane plates 6, spiraling inward to the fluid appropriating penetrations on the spacers 8. Cyclonic flow past the membrane sided plates 6 affords scouring of surface deposits from the membrane surfaces of the plates 6. The presence of the plates 6 engenders frictional velocity losses to the cyclonic flow 4. A fluid dynamic and a geometrical portent offset the frictional induced velocity decay. High velocity introduction of feed fluid 3 introduced at the outer periphery of the circular region 5 creates an initial high angular momentum of the feed fluid about the central axis. Conservation of angular momentum compels angular acceleration of the fluid as it courses radially inward toward the spacers. Moreover, the cross sectional area for flow lessens as the flow conveys radially inward, fostering radial acceleration of the fluid. Together the angular and radial acceleration proffer high velocity cross flow of the inward spiraling fluid upon the adjacent membrane surfaces.

Subsequent to pressured feed fluid, permeate flux penetrates the membrane surfaces of the plates 6 concurrent with the high velocity spiraling cross flow. The membrane plate assemblies 6 receive and convey the permeate from underneath the membranes toward one or more longitudinal permeate conduits 12 penetrating the stack core. Permeate conveys within the permeate conduits 12 to egress from the vessel 1.

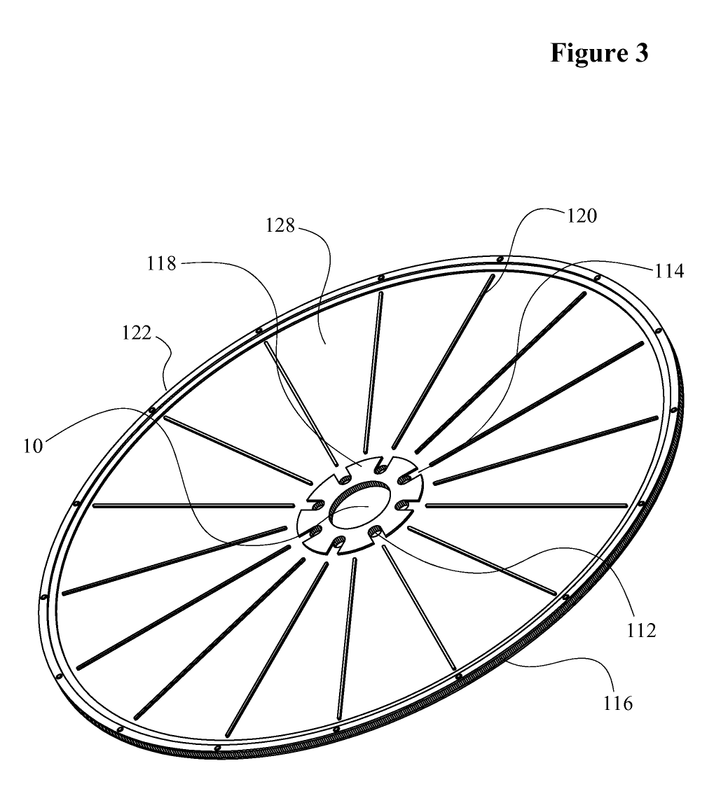

Referencing FIG. 3, an uncovered membrane support face is depicted. The plate 116 is comprised of three general sectors; a central hub 118, a recessed permeate conveyance basin 128, and a circumferential membrane support rim 122. The hub 118 is comprised of a central conduit 10 for conveyance of reject fluid. Permeate conveyance conduits 112 surround the central reject conduit 10. Permeate ducts 114 append the permeate conduits 112 to afford hydraulic communication between the permeate conduits 112 and the recessed permeate basin 128. Membrane support risers 120 confer sufficient membrane elevation to afford permeate conveyance in the basin 128 below the membrane 124 to the permeate ducts 114 and associated permeate conduits 112. Both sides of the plate 116 as illustrated in FIG. 3 are identical.

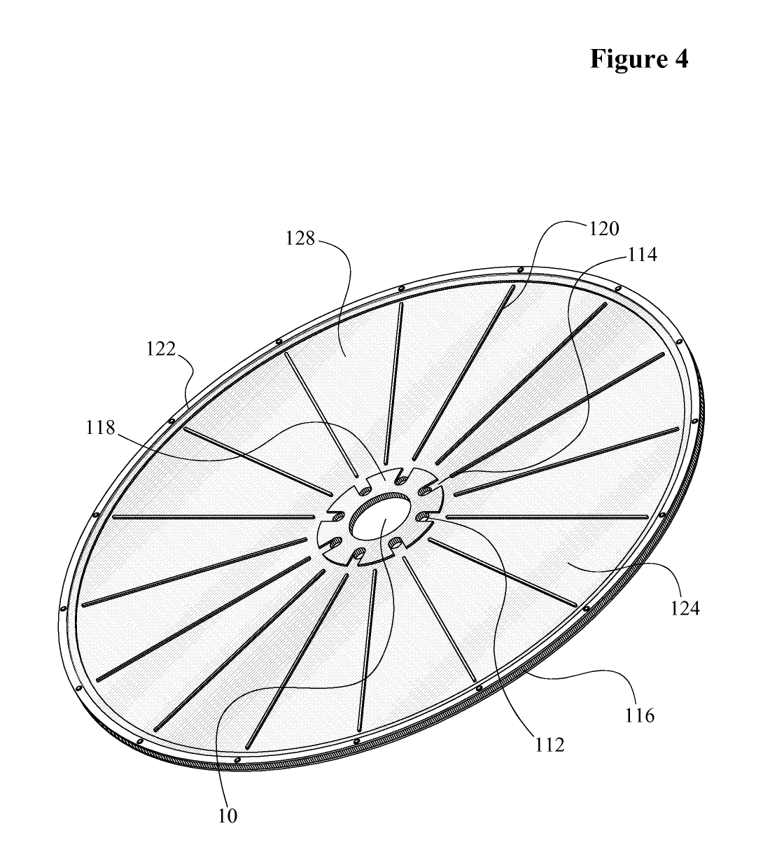

FIG. 4 illustrates a pressured membrane plate 116 with a sheet membrane 124 in place. The membrane 124 is secured to the plate 116 at the outer perimeter 122 and rests elevated from the basin 128 supported by the membrane support risers 120. The membrane 124 rests across the hub 118 with penetrations through the membrane 124 aligned with the central reject conduit 10 and the permeate conduits 112. Separate membranes 124 overlay both sides of the plate 116.

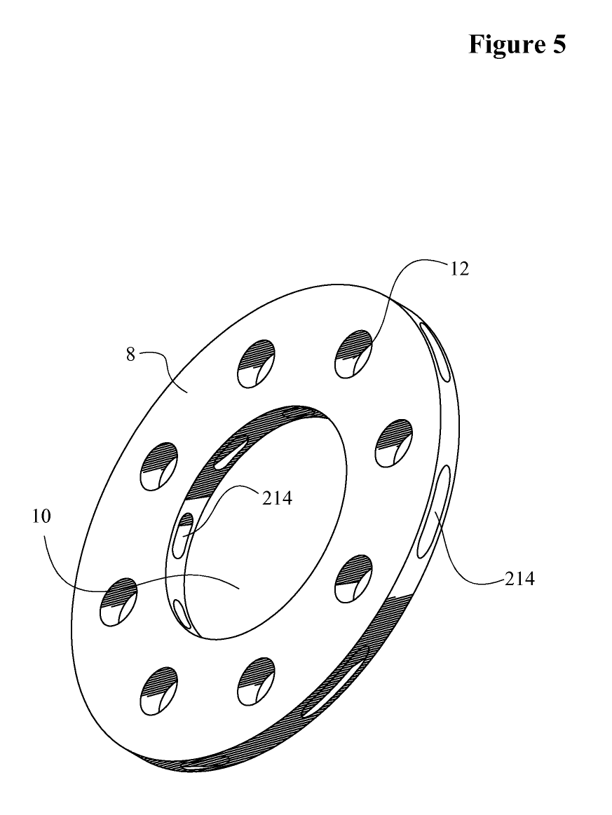

Referencing FIG. 5, a pressured membrane spacer element 8 is depicted. Spacers 8 are stacked adjacent to and alternating with membrane ensconced plate assemblies wherein spacers 8 press upon the membrane covered hubs 118 of the plates 116. The spacers 8 are longitudinally penetrated in an aligning identical pattern with the penetrations on the membrane plates 116. A central penetration 10 affords longitudinal conveyance of reject fluid through the spacer 8. Encircling (e.g. concentric) penetrations 12 longitudinally convey permeate through the spacer 8. Ducts 214 bridge radially from the external radius of the spacer 8 into the central reject conduit 10. Ducts 214 are oriented to not transect the underlying permeate conduits 12.

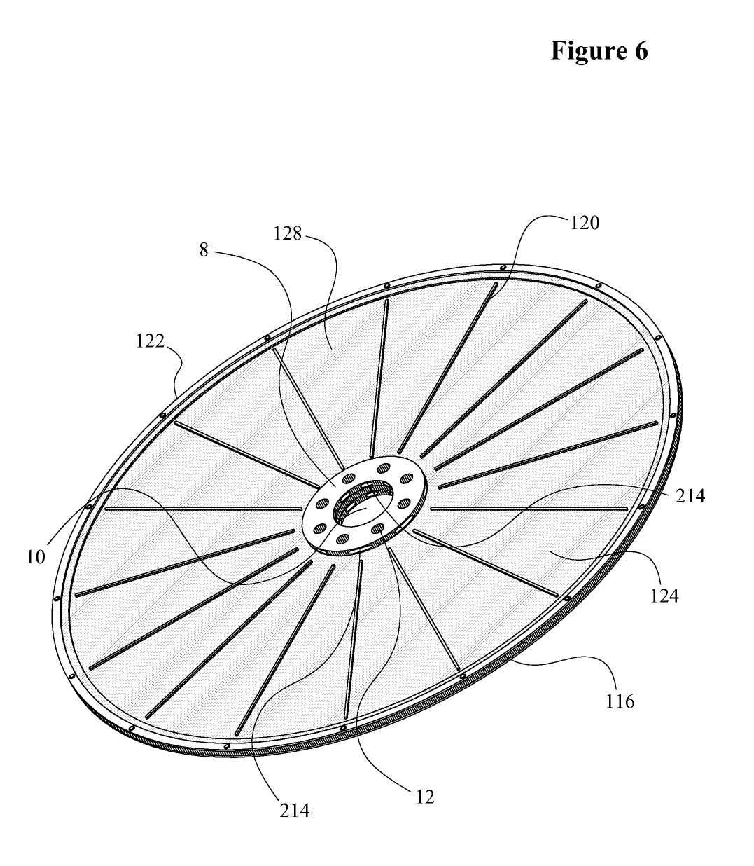

Thus, FIG. 6 illustrates an assembled pressure membrane and spacer assembly as would be employed. Feed fluid spirals at high velocity radially inward between the plate assemblies in the region supported by the spacers 8 while imbuing pressured, shearing contact with the membranes 124 on both sides of the plate 116. Permeate passes through the membranes 124 into the underlying permeate basins 128 of the plate 116. The permeate traverses the permeate basin 128 progressing centrally inward toward the hub 118 where the permeate passes through the permeate ducts 114 and enters the plate permeate conduit 112 to conveyance through the permeate conduits 12 and egress from the vessel 1.

Low pressure in the central longitudinal reject conduit 10, communicated through the radial bridge ducts 214 of the spacers 8, educes centrally inward spiraling of the feed fluid across the membranes 124 covering the plates 116. Permeate issues from the feed fluid as it spirals past the membranes 124. The reject fluid radially conveys through the bridge ducts 214 of the spacer 8 passing into and through the longitudinal reject conduit 10 to egress vessel 1.

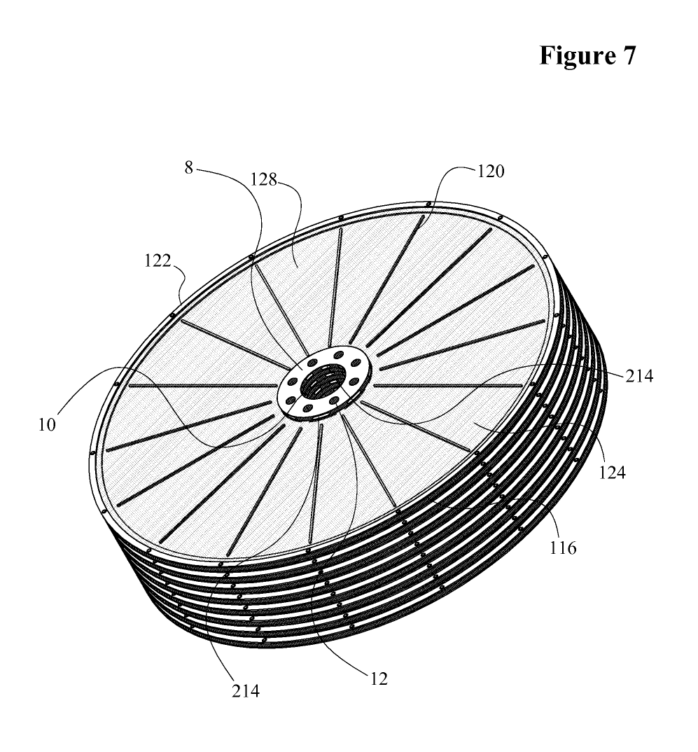

As FIG. 7 illustrates, alternate stacking of a plurality of spacers and pressured membrane imbued plates can afford a substantial presentation of membrane surface as would generally be desired for increased performance.

### Spiral Cross Flow Membrane Forward Osmosis Filtration Device

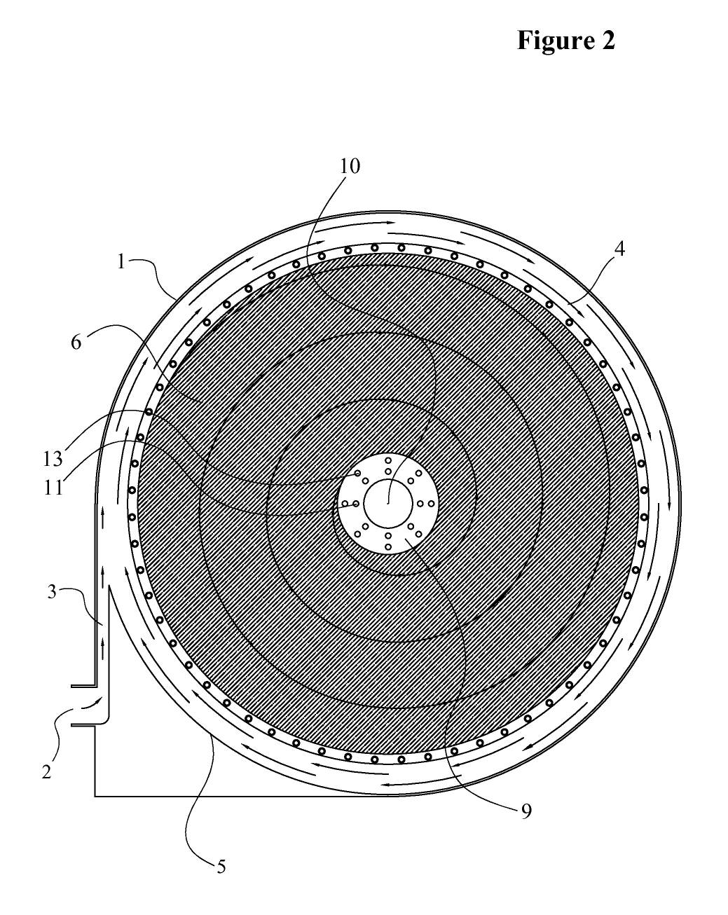

Turning to FIGS. 2 and 8-13 and for the exemplary purposes of this disclosure, a spiral cross flow membrane forward osmosis filtration device is shown.

With reference now to FIG. 2, a vessel 1 encloses a circular region 5 (or cylindrical as the case may be) in which one or more membrane sided plate assemblies 6 are centrally located. The plate assemblies are sandwiched between much smaller diameter cylindrical spacers 9, fashioning a longitudinal stack within the vessel. The spacers 9 and plates 6 are penetrated with three or more longitudinal penetrations to convey separate fluids into, within, and from the stack. The wall of the circular region 5 is penetrated with a fluid inlet 3. Feed fluid 2 is introduced at high velocity, typically ranging from 1 to 15 m/sec t through the fluid inlet 3 into the circular region 5 of the vessel 1. Higher inlet velocities are advantageous to enhance membrane cleanliness by inducing higher cross flow velocities upon the membrane surfaces; albeit with a caveat of higher power requirements. Accordingly, the inlet velocities are balanced to maximize membrane cleanliness but yet do so with a reasonable power requirement. A typical balance is about 5 m/sec inlet velocity. The fluid inlet 3 addresses the circular region 5 tangentially at sufficient tangential angle to engender cyclonic swirl 4 of the feed fluid 2 about the circular region 5. The spacers 9 are penetrated to convey feed fluid from the central region of the circular region 5 into a recycle conduit 10 which extends the length of the stack and egresses from vessel 1. Fluid exiting the vessel via conveyance through the spacers 9 and recycle conduit 10 affects an inward radial flow component to the cyclonic swirl 4. Accordingly the cyclonic swirl 4 progresses inward between the membrane plates 6, spiraling inward to the fluid appropriating penetrations on the spacers 9. Cyclonic flow past the membrane sided plates 6 affords scouring of surface deposits from the membrane surfaces of the plates 6. The presence of the plates 6 engenders frictional velocity losses to the cyclonic flow 4. A fluid dynamic and a geometrical portent offset the frictional induced velocity decay. High velocity introduction of feed fluid 3 introduced at the outer periphery of the circular region 5 creates an initial high angular momentum of the feed fluid about the central axis. Conservation of angular momentum compels angular acceleration of the fluid as it courses radially inward toward the spacers. Moreover, the cross sectional area for flow lessens as the flow conveys radially inward, fostering radial acceleration of the fluid. Together the angular and radial acceleration proffer high velocity cross flow of the inward spiraling fluid upon the adjacent membrane surfaces.

One or more of the longitudinal conduit penetrations 11 within the stack ingresses rich draw solution which is conveyed underneath the forward osmosis membranes covering the sides of the plate assemblies 6. Osmotic potential extracts fluid from the adjacent swirling feed fluid as permeate through the membranes. The permeate dilutes and alters the rich draw solution passing underneath the membrane to a lean draw solution. The lean draw solution conveys from the plate assemblies 6 into one or more lean draw solution longitudinal conduit penetrations 13 within the stack and egresses from the vessel 1.

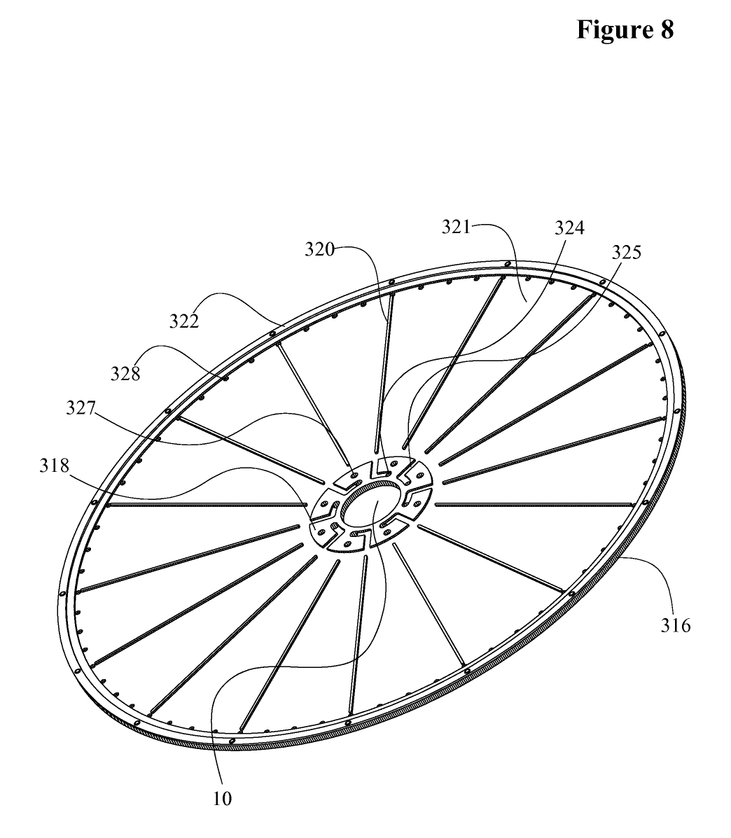

Referencing FIG. 8, an uncovered membrane support plate 316 is depicted. The plate 316 is comprised of three general sectors; a central hub 318, a recessed rich draw solution conveyance basin 321, and a circumferential membrane support rim 322. The hub 318 is comprised of a central conduit 10 for conveyance of reject fluid. Lean draw solution conduits 327 and rich draw solution conduits 324 surround the central reject conduit 10. Rich draw solution ducts 325 append the rich draw solution conduits 324 to afford hydraulic communication between the rich draw solution conduits 324 and the recessed rich draw solution basin 321. Membrane support risers 320 confer sufficient membrane elevation to afford rich draw solution conveyance in the basin 321 below the membrane from the rich draw solution ducts 325 and associated rich draw solution conduits 324. The outer periphery of the recessed rich draw solution conveyance basin 321 is penetrated with lean draw solution return ports 328.

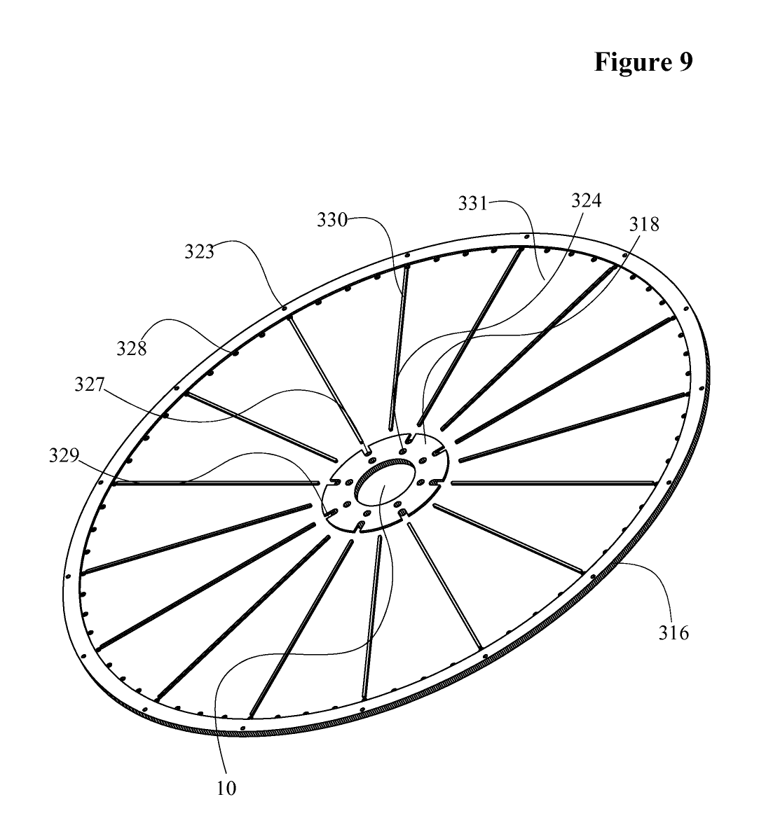

FIG. 9 illustrates the opposite side of the plate 316—the lean draw solution return side of plate 316. This side of plate 316 is also comprised of three general sectors; a central hub 318, a recessed lean draw solution conveyance basin 331 and a circumferential sealing and structural rim 323. The hub is comprised of a central conduit 10 for conveyance of reject fluid. Lean draw solution conduits 327 and rich draw solution conduits 324 surround the central reject conduit 10. Lean draw solution ducts 329 append the lean draw solution conduits 327 to afford hydraulic communication between the lean draw solution conduits 327 and the recessed lean draw solution basin 331. Plate support risers 330 rise to matching elevation with the rim 323 and the hub 318. Support risers 330 provide spacing support and structural integrity to the plate 316. The outer periphery of the recessed lean draw solution basin 331 is penetrated with lean draw solution return ports 328.

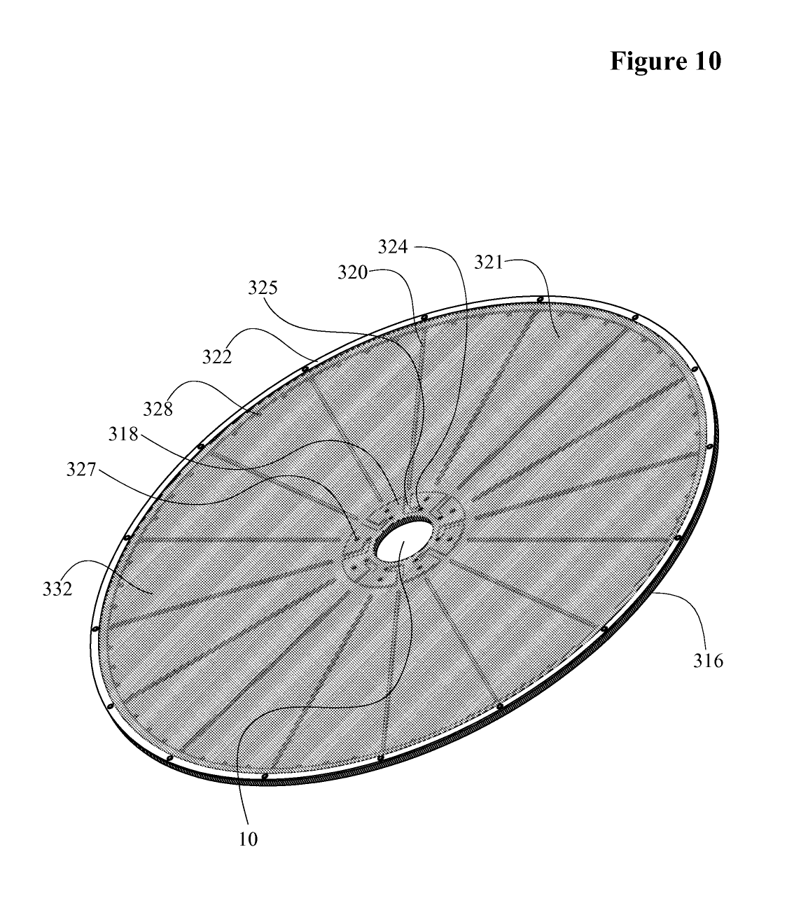

Referencing FIG. 10, the membrane support side of plate 316 is depicted with forward osmosis membrane sheet 332 in place. The membrane 332 is secured to the plate 316 at the outer perimeter 322 and rests elevated from the basin 321 supported by the membrane support risers 320. The membrane 332 rests across the hub 318 with penetrations through the membrane 332 aligned with the central reject conduit 10, the rich draw solution conduits 324 and the lean draw solution conduits 327.

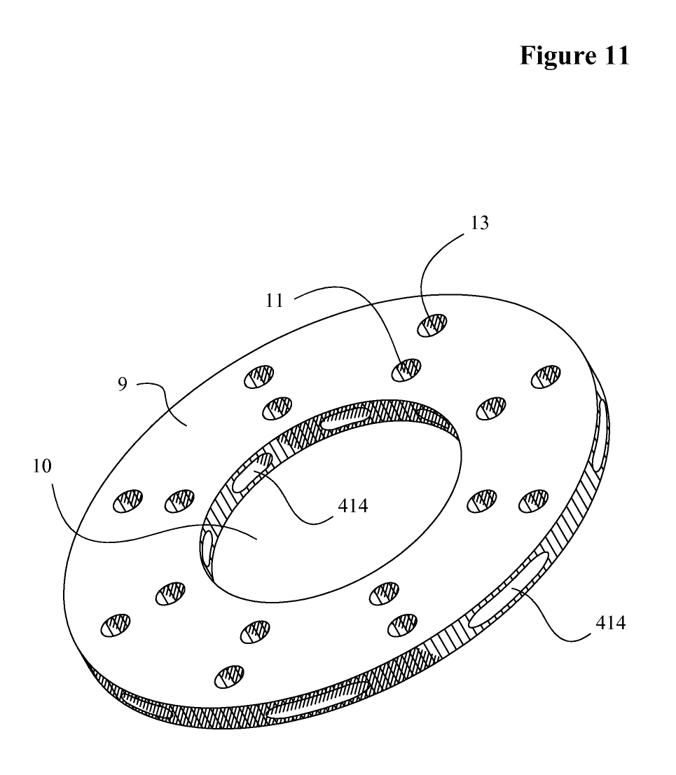

FIG. 11 illustrates membrane spacer element 9. Spacers 9 are stacked adjacent to and alternating with membrane ensconced plate assemblies wherein spacers 9 press upon the membrane covered hub regions 318 of the plates 316. The spacers 9 are longitudinally penetrated in an identical pattern with the membrane plates 316. A central penetration 10 affords longitudinal conveyance of reject fluid through the spacer 9. Longitudinal penetrations 13 and 11 encircle the reject conduit 10. Penetrations 13 convey lean draw solution and penetrations 11 convey rich draw solution through spacer 9. Ducts 414 bridge radially from the external radius of the spacer 9 into the central reject conduit 10. Ducts 414 are oriented to not transect the underlying rich draw solution conduits 13 or lean draw solution conduits 11.

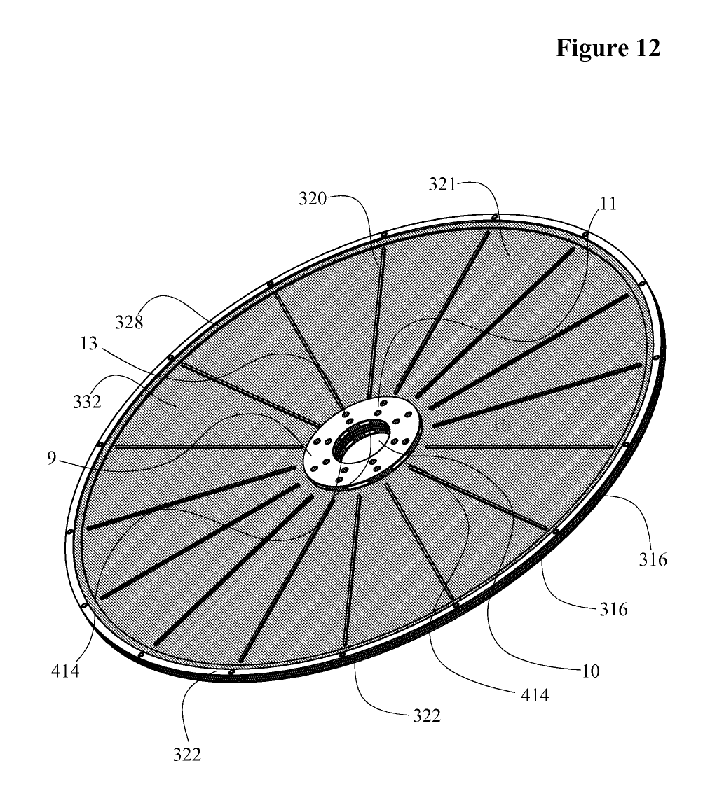

Thus, FIG. 12 illustrates a coupled or stacked forward osmosis plate and spacer assembly as would be employed. The coupled plate assembly is comprised of two plates 316 placed together back to back with the two lean draw solution return basins 331 comprising a central hollow to the coupled forward osmosis plates 316. Membranes 332 overlay the rich draw solution basins 321 of the two opposing plates 316. The membranes 332 are compress sealed upon the plate hub assemblies 318 by spacers 9 on opposing sides of the coupled plates 316. The membrane clasps 322 secure and seal the membranes 332 to the plates 316 as well coupling and sealing the opposing plates 316 together.

Feed fluid spirals at high velocity radially inward between the plate assemblies in the region supported by the spacers 9 while imbuing pressured, shearing contact with the membranes 332 on the opposing faces of the coupled plate 316 assembly. Rich draw solution conveys through the rich draw solution conduit 11 of the spacers 9 entering the rich draw solution conduits 324 of the two opposing plates 316. The rich draw solution streams through the rich draw solution ducts 325 from the rich draw solution conduits 324 into the rich draw solution basins 321 underlying the membranes 332 on both sides of the coupled plate assembly. The rich draw solution spreads radially outward through the rich draw solution basins 321 exploiting osmotic pressure to extract permeate through the overlying membranes 332 from the adjacent spiraling feed fluid flow. The permeate dilutes the rich draw solution as it spreads radially outward in the rich draw solution basin 321 presenting a lean draw solution at the outer periphery of the basin 321. The dilute, now lean draw solution exits the rich draw solution basin through the lean draw solution return ports 328 at the outer periphery of the rich draw solution basin 321 passing into the lean draw solution return basin 331 hollow between the coupled plates 316. The lean draw solution converges radially inward through the lean draw solution basins 331, eventually passing through the lean draw solution ducts 329 in the plate hubs 318 entering the lean draw solution conduit penetrations 327. The lean draw solution conveys through the lean draw solution conduits 13 in the spacers 9 for egress from the vessel 1.

Low pressure in the central longitudinal reject conduit 10, communicated through the radial bridge ducts 414 of the spacers 9 educes centrally inward spiraling of the feed fluid across the membranes 332 covering the coupled plates 316. Permeate issues from the feed fluid as it spirals past the membranes 332. The reject fluid radially conveys through the bridge ducts 414 of the spacers 9 passing into and through the longitudinal reject conduit 10 to egress the vessel 1.

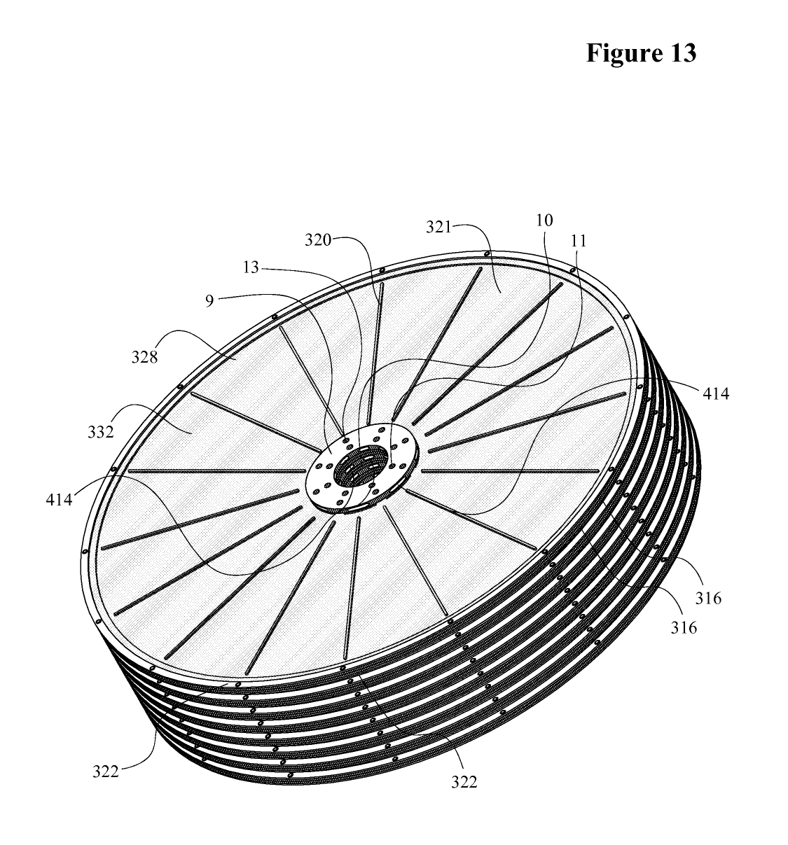

As FIG. 13 illustrates, alternate stacking of a plurality of coupled plate and spacer assemblies affords a substantial presentation of membrane surface as would generally be desired for increased performance.

### Other Implementations

The implementations just described are not the only implementations possible Many additional implementations are possible.

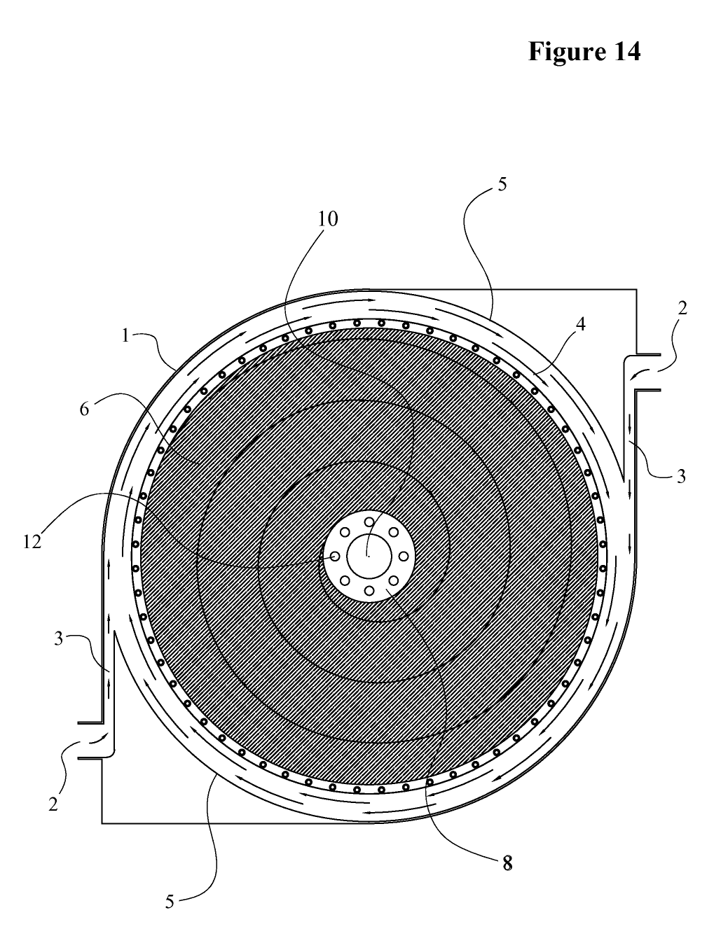

For the exemplary purposes of this disclosure, another spiral cross flow membrane pressure filtration device is depicted in FIG. 14. This implementation employs multiple feed fluid inlet ports 2 and cyclonic ingress ports 3 in a pressured membrane application. Such a configuration purveys both higher fluid velocities as well as more homogeneous swirl patterns; enhancing the performance.

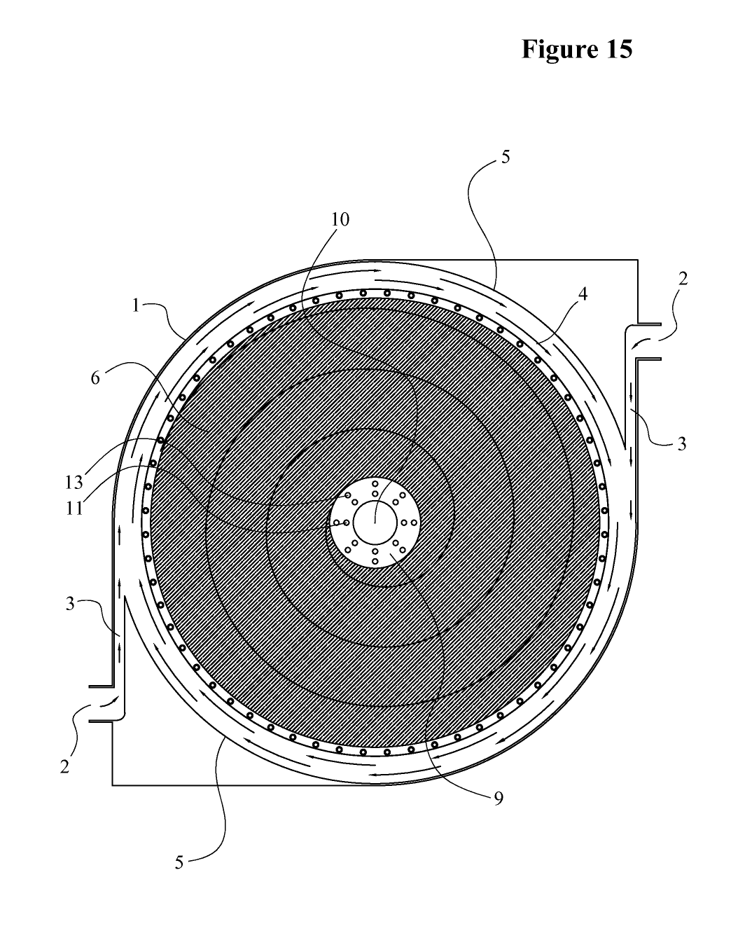

For the exemplary purposes of this disclosure, another spiral cross flow membrane forward osmosis filtration device is depicted in FIG. 15. This implementation employs multiple feed fluid inlet ports 2 and cyclonic ingress ports 3 in a forward osmosis application. Such a configuration purveys both higher fluid velocities as well as more homogeneous swirl patterns; enhancing the performance of forward osmosis implementations of the art.

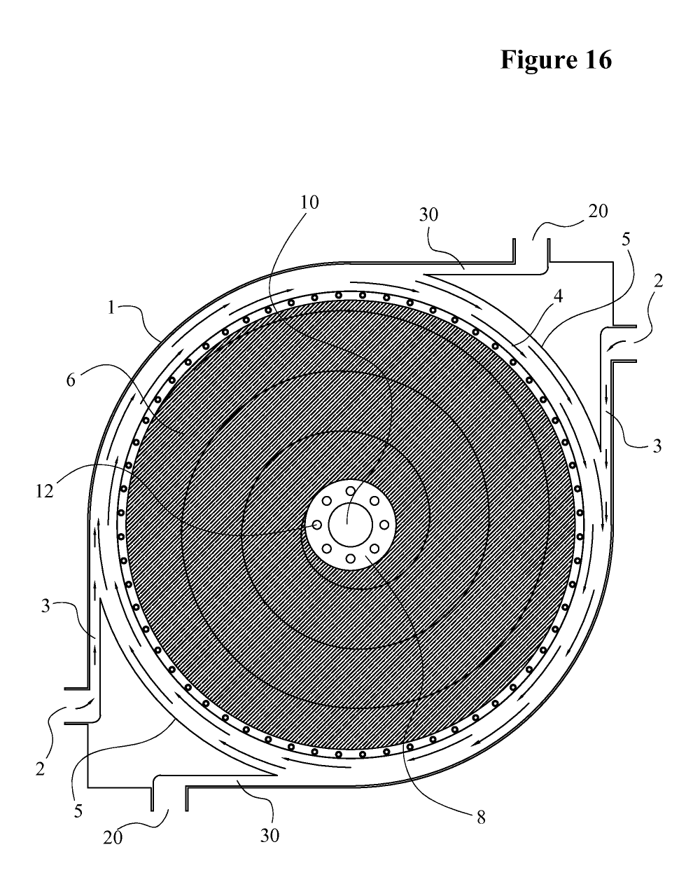

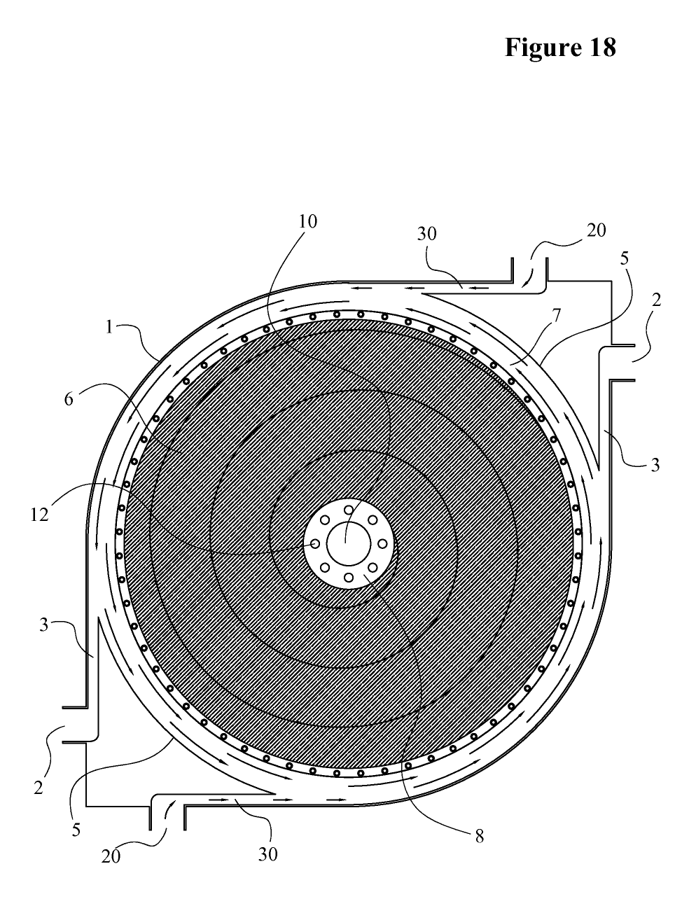

For the exemplary purposes of this disclosure, another spiral cross flow membrane pressure filtration device is depicted in FIGS. 16 and 18. This implementation employs multiple feed fluid inlet ports 2 and cyclonic ingress ports 3 as well opposing orientations of feed ports 20 and cyclonic ingress ports 30 in a pressured membrane application. Feed fluid enters in ports 2 and jets through ingress ports 3 into circular region 5 inducing a cyclonic clockwise swirl 4. Opposing ports 20 and 30 are quiescent during this mode of operation. Alternatively, feed fluid enters in ports 20 and jets through ingress port 30 into circular region 5 inducing a cyclonic counterclockwise swirl 7. Opposing ports 2 and 3 are quiescent during this mode of operation. The variance in operating modes is manifested in the reversal of cyclonic flows; reversing from clockwise 4 to counterclockwise 7. Periodic cyclonic reversal affords purging of streamline and shadow deposition of solids and detritus on the pressured membrane surfaces and presents a superior implementation.

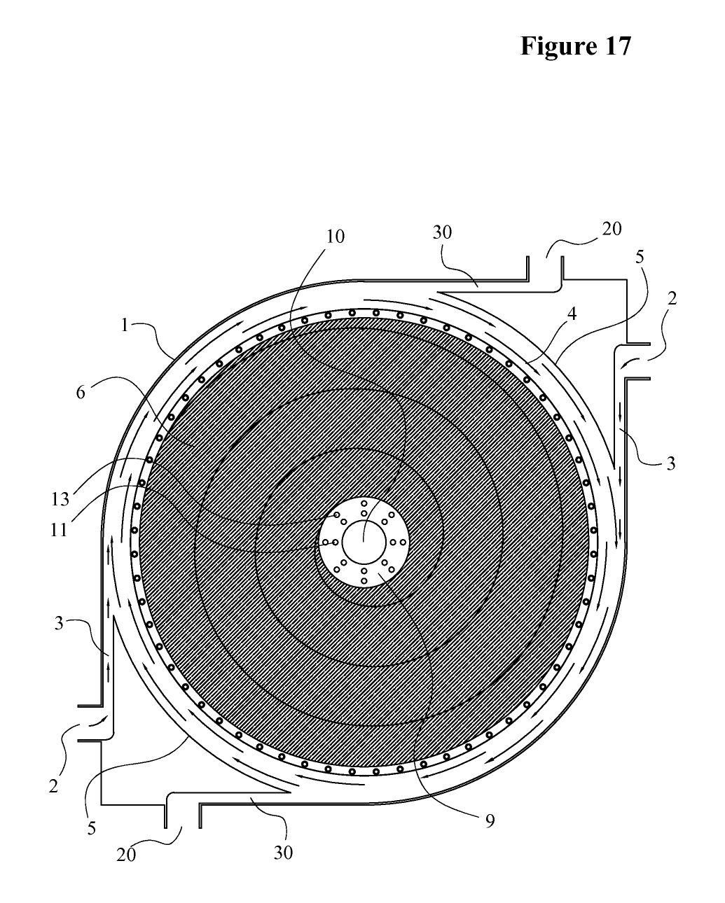

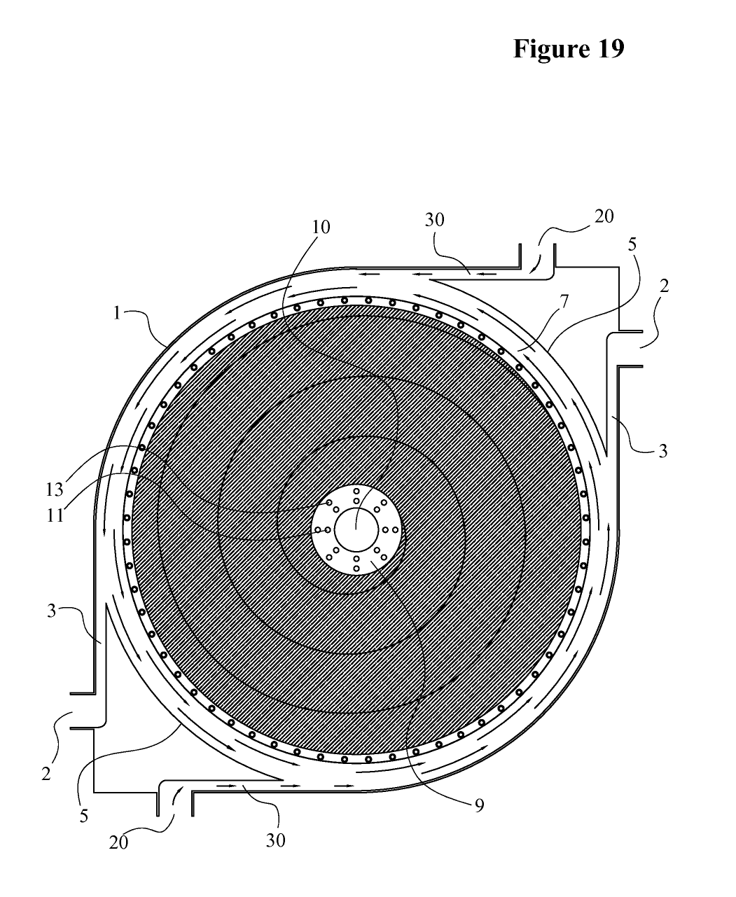

For the exemplary purposes of this disclosure, another spiral cross flow membrane forward osmosis filtration device is depicted in FIGS. 17 and 19. This implementation employs multiple feed fluid inlet ports 2 and cyclonic ingress ports 3 as well opposing orientations of feed fluid inlet ports 20 and cyclonic ingress ports 30 in a forward osmosis application. Feed fluid enters in ports 2 and jets through ingress ports 3 into circular region 5 inducing a cyclonic clockwise swirl 4. Opposing ports 20 and 30 are quiescent during this mode of operation. Alternatively, feed fluid enters in ports 20 and jets through ingress ports 30 into circular region 5 inducing a cyclonic counterclockwise swirl 7. Opposing ports 2 and 3 are quiescent during this mode of operation. The variance in operating modes is manifested in the reversal of cyclonic flows; reversing from clockwise 4 to counterclockwise 7. Periodic cyclonic reversal affords purging of streamline and shadow deposition of solids and detritus on the forward osmosis membrane surfaces and presents a superior implementation.

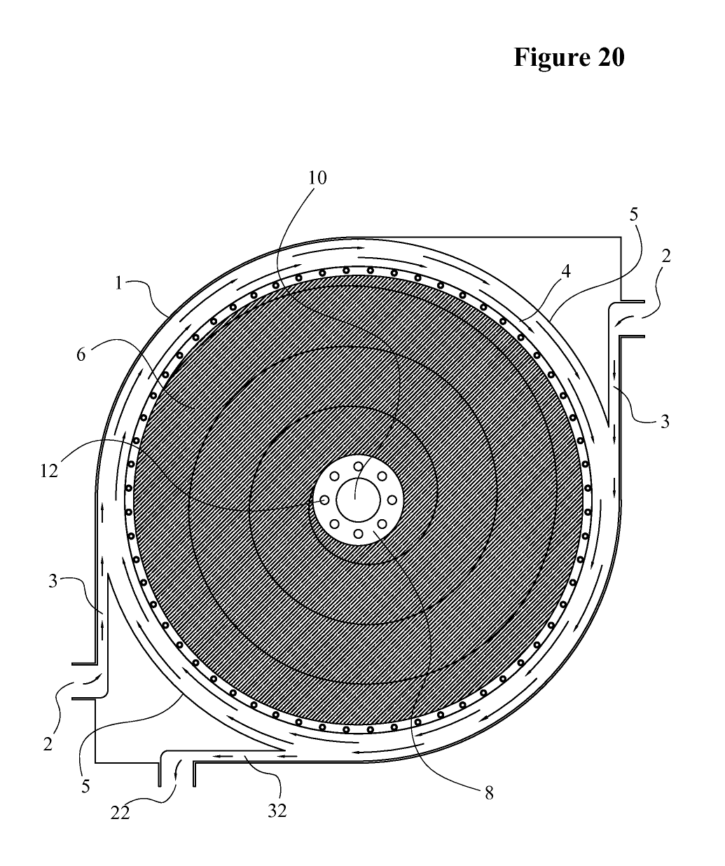

For the exemplary purposes of this disclosure, another spiral cross flow membrane pressure filtration device is depicted in FIG. 20. In a pressured membrane application, this implementation employs a scavenging vane, slot or port 32 that accesses the circular section 5 to scavenge solids or detritus from the cyclonic flow 4 for discharge from an egress port 22. The implementation exploits the centrifugal solids separation benefits associated with cyclonic flow 4 to scavenge solids and detritus from within the vessel 1. Ports 32 and 22 can be activated continuously for a continual blowdown of solids or detritus or periodically as required by feed fluid quality and other operational considerations.

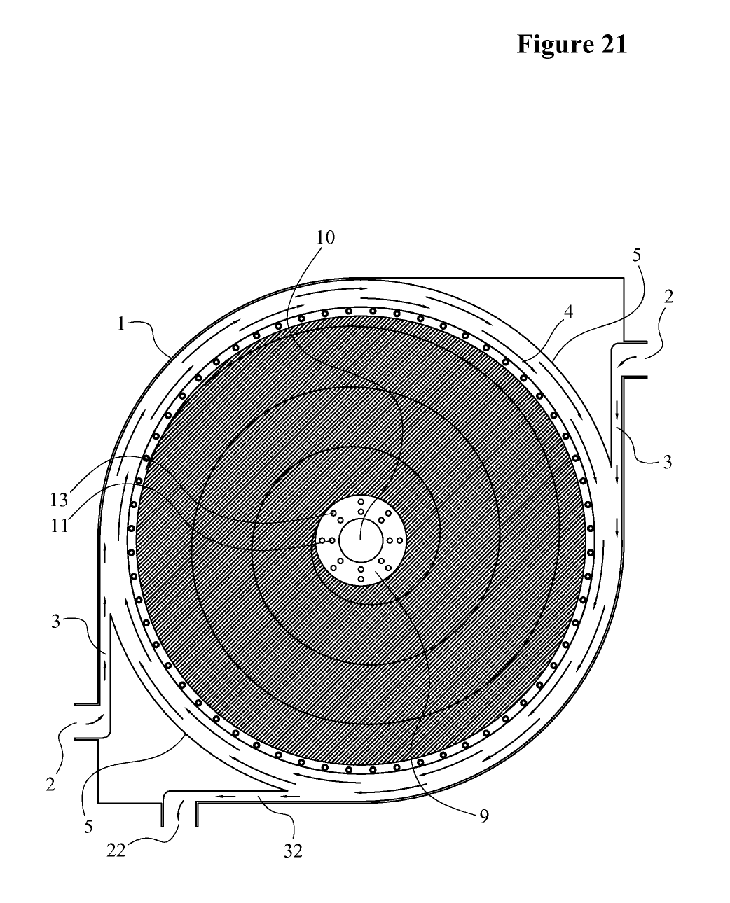

For the exemplary purposes of this disclosure, another spiral cross flow membrane forward osmosis filtration device is depicted in FIG. 21. In a forward osmosis application, this implementation employs a scavenging vane, slot or port 32 that accesses the circular section 5 to scavenge solids or detritus from the cyclonic flow 4 for discharge from an egress port 22. The implementation exploits the centrifugal solids separation benefits associated with cyclonic flow 4 to scavenge solids and detritus from within the vessel 1. Ports 32 and 22 can be activated continuously for a continual blowdown of solids or detritus or periodically as required by feed fluid quality and other operational considerations.

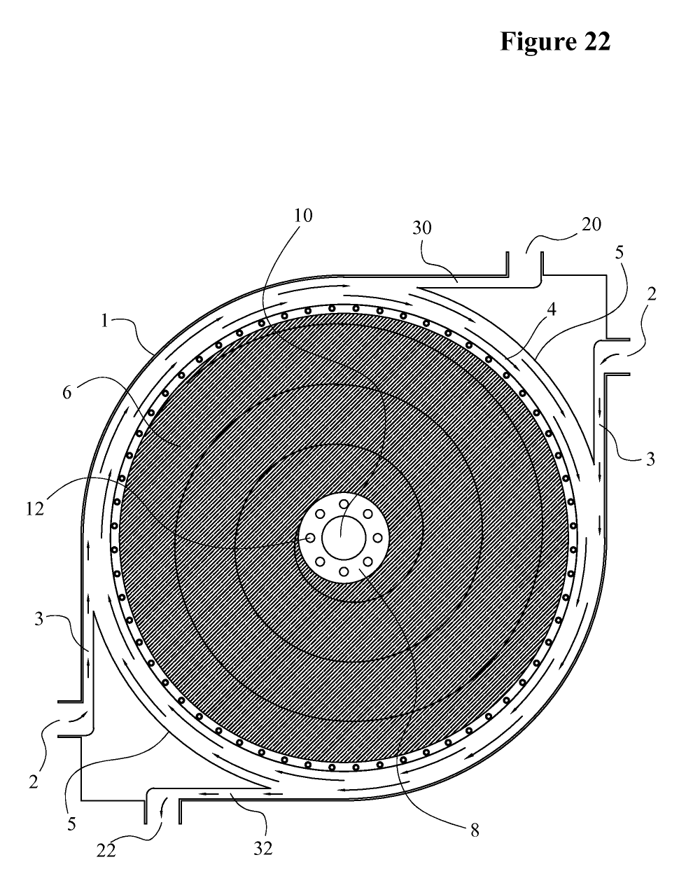

For the exemplary purposes of this disclosure, another spiral cross flow membrane pressure filtration device is depicted in FIG. 22. This implementation employs multiple feed fluid inlet ports 2 and cyclonic ingress ports 3 as well opposing orientations of feed ports 20 and cyclonic ingress ports 30 in a pressured membrane application. At least one set of feed fluid ports 20 and cyclonic ingress ports 30 are not quiescent, but rather when not providing feed fluid ingress they are employed as a scavenging slot, vane or port 32 which accesses the circular section 5 to scavenge solids or detritus from the cyclonic flow 4 for discharge from an egress port 22. The implementation exploits the centrifugal solids separation benefits associated with cyclonic flow 4 to scavenge solids and detritus from within the vessel 1. Ports 32 and 22 can be activated continuously while not providing fluid feed ingress or periodically as required by feed fluid quality and other operational considerations. It is optional in this implementation that a set of feed fluid inlet ports 2 and cyclonic ingress ports 3 can alternate as ports 32 and 22 for vessel scavenging when the cyclonic flow reverses 7 as is associated with ports 20 and 30 providing the feed fluid ingress and cyclonic generation.

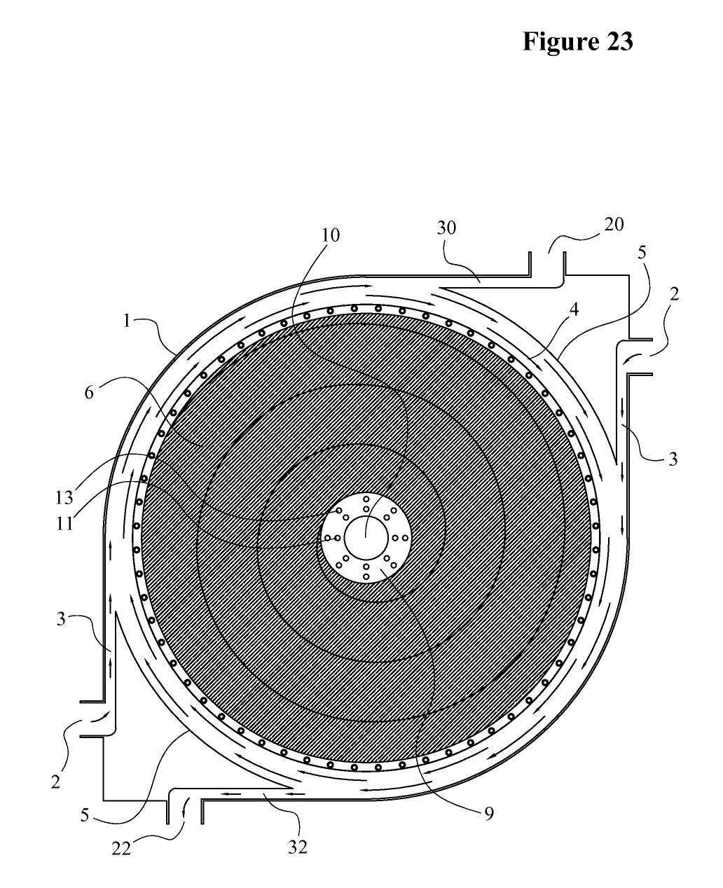

For the exemplary purposes of this disclosure, another spiral cross flow membrane forward osmosis filtration device is depicted in FIG. 23. This implementation employs multiple feed fluid inlet ports 2 and cyclonic ingress ports 3 as well opposing orientations of feed ports 20 and cyclonic ingress ports 30 in a forward osmosis application. At least one set of feed fluid ports 20 and cyclonic ingress ports 30 are not quiescent, but rather when not providing feed fluid ingress they are employed as a scavenging slot, vane or port 32 which accesses the circular section 5 to scavenge solids or detritus from the cyclonic flow 4 for discharge from an egress port 22. The implementation exploits the centrifugal solids separation benefits associated with cyclonic flow 4 to scavenge solids and detritus from within the vessel 1. Ports 32 and 22 can be activated continuously while not providing fluid feed ingress or periodically as required by feed fluid quality and other operational considerations. It is optional in this implementation that a set of feed fluid inlet ports 2 and cyclonic ingress ports 3 can alternate as ports 32 and 22 for vessel scavenging when the cyclonic flow reverses 7 as is associated with ports 20 and 30 providing the feed fluid ingress and cyclonic generation.

For the exemplary purposes of this disclosure, in some implementations the debris and detritus egress does not come from the cyclonic swirl. For example, in some implementations the vessel axis could be vertical. Then, the detritus egress would be from detritus sedimentation from the cyclonic flow into a lower section of the vessel. The detritus may or may not be extracted from the cyclonic swirl. Thus, the solids egress port could come from a non-cylindrical end surface of the vessel and also due to the fact that the cyclonic flow will have degraded in this settlement area, in a vertical configuration.

For the exemplary purposes of this disclosure, in some implementations, instead of two membrane plates, a single membrane plate may be included in a small vessel. Centrally located ports in the single membrane vessel sidewalls may address the radial inward flow. This implementation also eliminates the need for reject fluid port in spacers.

For the exemplary purposes of this disclosure, in some implementations, a single membrane plate vessel can be used with at least one spacer for flow and reject holes may be in the two end walls of the vessel, radially just outside the spacer. That is, reject is ported from the vessel walls centrally on one or both sides of the membrane plate rather than through the membrane plate core or spacer core.

For the exemplary purposes of this disclosure, implementations employing various combinations of portions of the foregoing implementations are certainly conceivable. It is plausible that vessels could enclose multiple compartments to facilitate sequential membrane types, chemical additions or draw solution conditioning.

For the exemplary purposes of this disclosure, implementations employing various configurations of inlet feed such as spiral slots, vaned slots, multiplicity of types and numbers of inlets, adjustable slots and multiple focused ingress port are plausible configurations and variances as well.

For the exemplary purposes of this disclosure, implementations wherein both ingress generated cyclonic flow and mechanical rotation of the plates are plausible.

For the exemplary purposes of this disclosure, implementations wherein both ingress generated cyclonic flow and mechanical spinning vane induced cyclones are plausible.

For the exemplary purposes of this disclosure, implementations engaging additional beneficial appliances are also feasible. Example of such would be the employ of centrifugal separation devices such as centrifuges, hydro-cyclones or clarifiers to concentrate reject or waste blowdown for recycle. Filtration devices could also be so used.

For the exemplary purposes of this disclosure, it is reasonable to envision thermal processes being employed in certain implementations. An example would be heating of the vessels, draw solutions or feed fluids to enhance flux rates.

For the exemplary purposes of this disclosure, it is conceivable that multiple combinations of vessels could be readily employed to independently and sequentially treat the feed fluids for various extraction or treatment opportunities. Separate tanks could also rationally be engaged to facilitate quiescence to enhance solids separation for decant recycling.

Further implementations are within the CLAIMS.

### Specifications, Materials, Manufacture

It will be understood that implementations are not limited to the specific components disclosed herein, as virtually any components consistent with the intended operation of a spiral cross flow membrane filtration device implementation may be utilized. Accordingly, for example, although particular components and so forth, are disclosed, such components may comprise any shape, size, style, type, model, version, class, grade, measurement, concentration, material, weight, quantity, and/or the like consistent with the intended operation of a spiral cross flow membrane filtration device implementation. Implementations are not limited to uses of any specific components, provided that the components selected are consistent with the intended operation of a spiral cross flow membrane filtration device implementation.

Accordingly, the components defining any spiral cross flow membrane filtration device implementation may be formed of any of many different types of materials or combinations thereof that can readily be formed into shaped objects provided that the components selected are consistent with the intended operation of a spiral cross flow membrane filtration device implementation. For example, the components may be formed of: rubbers (synthetic and/or natural) and/or other like materials; glasses (such as fiberglass), carbon-fiber, aramid-fiber, any combination thereof, and/or other like materials; polymers such as thermoplastics (such as ABS, Acrylic, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals and/or other like materials; alloys and/or other like materials; any other suitable material; and/or any combination thereof.

For the exemplary purposes of this disclosure, the membranes employed within this disclosure are not limited to any sheet type; examples of which may be pressure filters such coarse screen type, cloth type, paper type, micro-filter, ultra-filter, nanofilter and reverse osmosis or forward osmosis type membranes are all possible.

For the exemplary purposes of this disclosure, an FO membrane may be made from a thin film composite RO membrane. Such membrane composites include, for example, a cellulose ester membrane cast by an immersion precipitation process on a porous support fabric such as woven or nonwoven nylon, polyester or polypropylene, or preferably, a cellulose ester membrane cast on a hydrophilic support such as cotton or paper. The RO membrane may be rolled using a commercial thin film composite, sea water desalination membrane. The membranes used for the FO element (in any configuration) may be hydrophilic, membranes with salt rejections in the 80% to 95% range when tested as a reverse osmosis membrane (60 psi, 500 PPM NaCl, 10% recovery, 25.degree. C.). The nominal molecular weight cut-off of the membrane may be 100 daltons. The membranes may be made from a hydrophilic membrane material, for example, cellulose acetate, cellulose proprianate, cellulose butyrate, cellulose diacetate, blends of cellulosic materials, polyurethane, polyamides. The membranes may be asymmetric (that is, the membrane may have a thin rejection layer on the order of 10 microns thick and a porous sublayer up to 300 microns thick) and may be formed by an immersion precipitation process. The membranes may be either unbacked, or they may have a very open backing that does not impede water reaching the rejection layer, or they may be hydrophilic and easily wick water to the membrane. Thus, for mechanical strength they may be cast upon a hydrophobic porous sheet backing, wherein the porous sheet is either woven or non-woven but having at least about 30% open area. The woven backing sheet may be a polyester screen having a total thickness of about 65 microns (polyester screen) and total asymmetric membrane is 165 microns in thickness. The asymmetric membrane may be cast by an immersion precipitation process by casting a cellulose material onto a polyester screen. The polyester screen may be 65 microns thick, 55% open area.

Various spiral cross flow membrane filtration device implementations may be manufactured using conventional procedures as added to and improved upon through the procedures described here. Some components defining a spiral cross flow membrane filtration device implementation may be manufactured simultaneously and integrally joined with one another, while other components may be purchased pre-manufactured or manufactured separately and then assembled with the integral components.

Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled with one another in any manner, such as with adhesive, a weld, a fastener, wiring, any combination thereof, and/or the like for example, depending on, among other considerations, the particular material forming the components.

### Use, Ramifications, Scope

Implementations of a spiral cross flow membrane filtration device and process are particularly useful in forward osmosis/water treatment applications as previously explained. However, implementations are not limited to uses relating to forward osmosis applications. Rather, any description relating to forward osmosis applications is for the exemplary purposes of this disclosure, and implementations may also be used with similar results in a variety of other applications.

Thus, the excellent attributes of a spiral cross flow membrane filtration device afford the trouble free application of all types of membrane filtration media and associated applications; coarse strainer, microfilter, ultrafilter, nanofilter, and reverse osmosis as well. The cleanliness and ease of service substantially advances the durability of membranes and minimizes the cleaning, flushing and associated maintenance burdens typical of the prior art.

This disclosure provides a means to efficiently and robustly employ membrane based filtration and treatment processes in the presence of poor quality feed fluids as well as providing a uniquely easy means to service and replace individual membrane elements. The advantages over conventional techniques are substantial.

High solids content and poor quality feed fluids can be processed without plugging fouling or blinding. This results in enhanced operational reliability, less chemical costs for cleaning, longer membrane life, enhanced flux rates and throughput performance, less down time, and lower pumping energy use.

The ability to process high solids content and poorer quality fluids eliminates the need for expensive pretreatment technologies. Pre-filtration, screening, settling, coagulation, flocculation and other processes and technologies common and necessary with conventional techniques are not required, thereby eliminating high capital and operating expenses as well as inefficiencies associated with these pretreatment technologies.

The superior capacity to successfully process poor quality feed fluids provides the unique capability to process normal quality waters to a much higher level of solids concentration and poorer quality than conventional techniques. This substantial advantage affords the unique ability to generate more valuable product with less feed fluid and less wasted volume.

The unique membrane structure and support arrangement provides extreme ease of membrane servicing and replacement. In contrast to conventional techniques, the membrane surfaces are not configured as non-accessible spiraled cartridges or tiny tubular surfaces prone to plugging. Instead, the membrane surfaces are each individually and easily accessible, cleanable and replaceable.

Cleansing high velocity cross-flow employs no flow shadowing distribution bars or reception bars. Instead, shadow free, high velocity flow is provided, eliminating the blinding and plugging resulting from shadow effect solids build up and associated service requirements and performance degradation.

Additionally, the high velocity cleansing cross-flow is entirely hydraulic driven, eliminating mechanical stresses imposed upon membranes by swirling mechanical blades for example. Further since mechanical shearing, tearing or impaction issues are nonexistent, the induced swirl velocity limitations upon the membranes are lax, permitting much higher cross-flow velocities and the associated much higher membrane cleansing performance.

Forward osmosis implementations benefit from the fully countercurrent radially inward feed flow and radially outward rich draw solution flow providing superior forward osmosis flux rates.

The unique ability to reverse flow patterns provides much more efficient membrane surface scouring by eliminating the inevitable streamline and shadow deposition burdens common to conventional techniques.

The unique capacity to employ cyclonic centrifugal separation of solids and detritus for continuous or periodic blowdown is a tremendous advantage over conventional techniques. This feature affords the ability to employ poorer quality feed fluid, reduce waste, increase durability and reliability, reduce maintenance, and extend the membrane lifecycle.

Multiple coupled stacked plate and spacer assemblies with longitudinal feed fluid slots proffer parallel feed fluid contact to all the membranes in the vessel eliminating a troublesome propensity of conventional techniques of creating a solids content gradient upon sequentially contacted membranes. Accordingly, this parallel feed affords elimination of segregated fouling or blinding and purveys the maximum flux through the membranes as a whole. Additionally, in forward osmosis applications, the parallel feed bestows the highest osmotic pressure and maximum flux through the membranes.

In places where the description above refers to particular implementations, it should be readily apparent that a number of modifications may be made without departing from the spirit thereof and that these implementations may be alternatively applied. Other implementations presently existing or later to be developed, which perform substantially the same function or achieve substantially the same result as the corresponding implementations described herein, may be utilized. The accompanying CLAIMS are intended to cover such modifications as would fall within the true spirit and scope of the disclosure set forth in this document. The presently disclosed implementations are, therefore, to be considered in all respects as illustrative and not restrictive, the scope of the disclosure being indicated by the appended CLAIMS rather than the foregoing DESCRIPTION. All changes that come within the meaning of and range of equivalency of the CLAIMS are intended to be embraced therein.

1. A membrane filtration device comprising:
a vessel with a substantially cylindrical surface therein;
at least one fluid conveyance penetrating the vessel; and
at least one membrane imbued plate centrally penetrated with at least two conduits with the at least one membrane imbued plate being suspended central and axially aligned within the cylindrical surface.

2. The device of claim 1 wherein the at least one fluid conveyance is oriented relative to the cylindrical surface sufficient to generate unidirectional cyclonic type flow substantially about an internal axis of the cylindrical surface when ingress feed fluid is conveyed therein through the at least one fluid conveyance.

3. The device of claim 1 wherein the at least two conduits are ported external to the vessel, at least one conduit providing membrane permeate egress and at least one conduit providing spent reject fluid egress.

4. The device of claim 1 wherein the at least one membrane imbued plate is contacted by at least one smaller spacer providing space for feedwater cross with at least one aligning conduit penetration.

5. The device of claim 4 wherein the at least one aligning conduit penetration is a perpendicular aperture radially without.

6. The device of claim 1 wherein the at least one fluid conveyance comprises at least two fluid conveyances penetrating the vessel, wherein the conveyances are alternately oriented relative to the cylindrical surface sufficient to generate cyclonic type flow in either direction substantially about an internal axis of the cylindrical surface when ingress fluid is conveyed via the appropriately oriented fluid conveyance.

7. The device of claim 1 wherein the at least one fluid conveyance comprises at least two fluid conveyances penetrating the vessel, wherein at least one conveyance egresses the vessel for scavenging of solids and unwanted detritus.

8. The device of claim 1 wherein the at least one membrane imbued plate comprises at least one forward osmosis membrane imbued plate centrally penetrated with at least two conduits.

9. The device of claim 8 wherein the at least two conduits are ported externally to the vessel, wherein at least one conduit ingresses a rich draw solution, at least another conduit egresses a lean draw solution.

10. The device of claim 9 wherein rich draw solution conduits convey rich draw solution ingress from external to the vessel to contact membranes on the forward osmosis membrane imbued plates.

11. The device of claim 9 wherein lean draw solution conduits convey lean draw solution from the forward osmosis imbued membrane plates for external egress from the vessel

12. The device of claim 8 wherein the at least one forward osmosis membrane imbued plate comprises at least two forward osmosis membrane imbued plates and the at least two forward osmosis membrane imbued plates are separated by at least one smaller spacer with aligning conduit penetrations of which spent reject fluid aligning conduits are perpendicularly apertured radially without.

13. The device of claim 8 wherein the at least one fluid conveyance comprises at least two fluid conveyances penetrating the vessel, wherein the conveyances are alternately oriented relative to the cylindrical surface sufficient to generate cyclonic type flow in either direction substantially about an internal axis of the cylindrical surface when ingress fluid is conveyed via the appropriately oriented fluid conveyance.

14. The device of claim 8 wherein the at least one fluid conveyance comprises at least two fluid conveyances penetrating the vessel, wherein at least one conveyance egresses the vessel for scavenging of solids and unwanted detritus from the vessel.

15. A process for spiral cross-flow pressured membrane filtration comprising the steps of:
providing a vessel with a substantially cylindrical surface therein, at least one fluid conveyance penetrating the vessel, at least two membrane imbued plates centrally penetrated with at least two conduits with the at least two membrane imbued plates being suspended central and axially aligned within the cylindrical surface, and at least one spacer between the at least two membrane imbued plates;
supplying feed fluid into the vessel through the at least one fluid conveyance;
feed fluid velocity and trajectory generating high cyclonic flow in the cylindrical surface region on and about the at least two membrane imbued plates;
exiting spent reject fluid from between the at least two membrane imbued plates thereby generating high velocity, radially inward spiraling cyclonic flow across membrane surfaces to efficiently cleanse membrane surfaces;
conveying spent reject fluid in at least one of the at least two conduits from the vessel;
flowing permeate from spiraling cyclonic feed fluid through membranes and into at least one of the at least two conduits; and
conveying the permeate in one of the at least two conduits from the vessel.

16. The process of claim 15 wherein:
the step of providing a vessel further comprises providing a vessel with at least one clockwise oriented fluid conveyance and at least one counterclockwise oriented fluid conveyance;
the step of supplying feed fluid comprises:
periodically supplying feed fluid into the vessel through the at least one clockwise fluid conveyance so as to incite cyclonic flow in a clockwise direction; and
periodically supplying feed fluid into the vessel through the at least one counterclockwise fluid conveyance so as to incite cyclonic flow in a counterclockwise direction, the reversal of high velocity spiraling cyclonic flow efficiently cleansing and eliminating depositions on membrane surfaces.

17. The process of claim 16 wherein one of the step of periodically supplying feed fluid into the vessel through the at least one clockwise fluid conveyance, the step of periodically supplying feed fluid into the vessel through the at least one counterclockwise fluid conveyance, and both steps further comprises:
employing the at least one other conveyance as egress from the vessel to scavenge and discharge solids and other unwanted detritus circulating within an outer periphery of cyclonic flow within the cylindrical surface, the reversal of high velocity spiraling cyclonic flow and peripheral solids and detritus scavenging efficiently cleansing and eliminating depositions on membrane surfaces.

18. A process for spiral cross-flow forward osmosis membrane filtration comprising the steps of:
providing a vessel with a substantially cylindrical surface therein, at least one fluid conveyance penetrating the vessel, at least two forward osmosis membrane imbued plates centrally penetrated with at least three conduits with the at least two forward osmosis membrane imbued plates being suspended central and axially aligned within the cylindrical surface, and at least one spacer between the at least two forward osmosis membrane imbued plates;
supplying feed fluid into the vessel through the at least one fluid conveyance penetrating the vessel;
feed fluid velocity and trajectory generating high cyclonic flow in the cylindrical surface region on and about the at least two forward osmosis membrane imbued plates, thereby efficiently cleansing membrane surfaces;
exiting spent reject fluid from between the at least two forward osmosis membrane imbued plates thereby generating high velocity spiraling cyclonic flow across membrane surfaces to efficiently cleanse membrane surfaces;
conveying spent reject fluid in at least one of the at least three conduits from the vessel;
conveying ingressing rich draw solution from external to the vessel via at least one of the at least three conduits to contact membranes thereby inducing osmotic pressure;
osmotic pressure inducing flux of permeate through membranes from adjacent cyclonically swirling feed fluid, the permeate diluting the rich draw solution and flowing into at least one of the at least three conduits; and
conveying diluted rich draw solution in at least one of the at least three conduits from the vessel.

19. The process of claim 18 wherein:
the step of providing a vessel further comprises providing a vessel with at least one clockwise oriented fluid conveyance and at least one counterclockwise oriented fluid conveyance penetrating the cylindrical surface;
the step of supplying feed fluid comprises:
periodically supplying feed fluid into the vessel through the at least one clockwise fluid conveyance so as to incite cyclonic flow in a clockwise direction; and
periodically supplying feed fluid into the vessel through the at least one counterclockwise fluid conveyance so as to incite cyclonic flow in a counterclockwise direction, the reversal of high velocity spiraling cyclonic flow efficiently cleansing and eliminating depositions on membrane surfaces.

20. The process of claim 19 wherein one of the step of periodically supplying feed fluid into the vessel through the at least one clockwise fluid conveyance, the step of periodically supplying feed fluid into the vessel through the at least one counterclockwise fluid conveyance, and both steps further comprises:
employing the at least one other conveyance as egress from the vessel to scavenge and discharge solids and other unwanted detritus circulating within an outer periphery of cyclonic flow within the cylindrical surface, the reversal of high velocity spiraling cyclonic flow and peripheral solids and detritus scavenging efficiently cleansing and eliminating depositions on membrane surfaces.
